(19) United States
(12) Patent Application Publication
(10) Pub. No.: US 2025/0328754 A1
(43) Pub. Date: Oct. 23, 2025

(54) Adaptive Data System And A Method For Cognitive Data Processing

(71) Applicant: Dataquantum Inc., Fairfax, VA (US)

(72) Inventor: Naveen SRINIVAS, Bengaluru (IN)

(21) Appl. No.: 19/182,576

(22) Filed: Apr. 17, 2025

Related U.S. Application Data
(60) Provisional application No. 63/635,947, filed on Apr. 18, 2024.

(51) Int. Cl. G06N 3/0455; G06N 3/049; G06N 3/092

(52) U.S. Cl. CPC G06N 3/0455; G06N 3/049; G06N 3/092

(57) ABSTRACT

An adaptive data system (ADS) for cognitive data processing is disclosed. The ADS includes an adaptive semantic preprocessor, a trigger detector, a temporal batching engine, a symbolic encoder, and a dynamic cognitive transformer engine. The adaptive semantic preprocessor is configured to receive input data from one or more databases and identify cognitive data attributes comprising one or more contextual, semantic, and temporal attributes from the received input data. The trigger detector is configured to identify semantic divergence of the identified cognitive data attributes and provide a standardized data. The temporal batching engine is configured to provide a high-dimensional cognitive data from the standardized data. The symbolic encoder compresses the high-dimensional cognitive data. The dynamic cognitive transformer engine is configured to determine decision making rules, analyze the compressed high-dimensional cognitive data based on the decision making rules and provide recommendations based on an outcome of the analysis to a user.

### CROSS REFERENCE TO RELATED APPLICATIONS

The present disclosure takes priority from the provisional patent application 63/635,947, filed on Apr. 18, 2024, and the entire contents of the priority patent application are incorporated herein by reference.

### TECHNICAL FIELD

The present disclosure generally relates to data management and more particularly to adaptive data systems wherein data is transformed to cognitive data which is low frequency processing using adaptive symbolic encoding.

### BACKGROUND

Traditional data systems are systems that mostly transform data into rigid mappings with respect to infrastructures and expected outcomes. The efficiencies are limited to the scope of initial schemas or architectures chosen. Achieving optimal equilibrium in such systems are limited and enforces high operational costs. Further, traditional systems often lag when working with large data sets or big data environment, causing delays in decision-making and insights extraction. As the data landscape expands, so do the complexities of managing computational cost and network cost. The challenge of optimizing resources is faced across data warehousing, data lakes, and databases.

One existing system that process large amounts of data use cognitive data processing. Cognitive data refers to data, which is represented by contextual, temporal, and semantic attributes. However, even existing cognitive data systems cause delay in decision-making and insights extraction.

There is an unmet need for a system and method for processing large datasets or in a big data environment to enable low frequency processing and low compute of cognitive data.

### SUMMARY

To eliminate the above-mentioned disadvantages, the primary objective of the present disclosure is to provide a system and method for accessing large datasets or typically in a big data environment.

One objective of the present disclosure is to provide an adaptive data system (ADS) for processing cognitive data. ADS Architecture gives the ability to treat data, infrastructure and expected outcome as a single entity living in equilibrium optimally in the eco system provided. ADS cognition acts as an agent to optimally maintain this system in equilibrium for expected outcomes.

Accordingly, an adaptive data system for cognitive data processing is disclosed. The adaptive data system includes an adaptive semantic preprocessor. The adaptive semantic preprocessor is configured to receive input data from one or more databases. Further, the adaptive semantic preprocessor is configured to identify cognitive data attributes comprising one or more contextual, semantic, and temporal attributes from the received input data. The adaptive semantic preprocessor is configured to adaptively simulate cognitive data absent in a spectrum of the received input data to provide a first data of the identified cognitive data attributes. The adaptive data system includes a trigger detector configured to identify semantic divergence of the identified cognitive data attributes. The trigger detector provides a standardized data of the identified cognitive data attributes from the first data. The adaptive data system includes a temporal batching engine configured to group the standardized data based on time intervals. The temporal batching engine provides a high-dimensional cognitive data from the standardized data, wherein the high-dimension cognitive data comprises information of the transition of the cognitive data attributes at various time intervals. The adaptive data system includes a symbolic encoder for compressing the high-dimensional cognitive data. The adaptive data system includes a dynamic cognitive transformer engine configured to determine decision making rules, wherein the decision making rules are determined dynamically based on the high-dimensional cognitive data and comprises at least one of clustering, left/right (L-system) decision making rule, and composite rules. The dynamic cognitive transformer engine analyzes the compressed high-dimensional cognitive data to derive insights of interconnected data paths to desired outcomes based on the decision making rules. The dynamic cognitive transformer engine provides recommendations based on an outcome of the analysis to a user.

A method for cognitive data processing is disclosed. The method includes receiving, by an adaptive semantic preprocessor, input data from one or more databases. The method includes identifying, by the adaptive semantic preprocessor, cognitive data attributes comprising one or more contextual, semantic, and temporal attributes from the received input data. The method includes adaptively simulating cognitive data absent in a spectrum of the received input data, by the adaptive semantic preprocessor, to provide a first data of the identified cognitive data attributes. The method includes identifying, by a trigger detector, semantic divergence of the identified cognitive data attributes. The method includes providing a standardized data of the identified cognitive data attributes from the first data. The method includes grouping, by a temporal batching engine, the standardized data based on time intervals. The method includes providing a high-dimensional cognitive data from the standardized data, wherein the high-dimension cognitive data comprises information of the transition of the cognitive data attributes at various time intervals. The method includes compressing, by a symbolic encoder, the high-dimensional cognitive data. The method includes determining decision making rules, by the cognitive transformer engine, wherein the decision making rules are determined dynamically based on the high-dimensional cognitive data and comprises at least one of clustering, left/right (L-system) decision making rule, and composite rules. The method includes analyzing the compressed high-dimensional cognitive data to derive insights of interconnected data paths to desired outcomes based on the decision making rules. The method includes providing recommendations based on an outcome of the analysis to a user.

An adaptive data system for cognitive data processing is disclosed. The adaptive data system includes a processor. The adaptive data system includes a data bus coupled to the processor and a non-transitory, computer-readable storage medium embodying computer program code, the non-transitory, computer-readable storage medium being coupled to the data bus, the computer program code interacting with a plurality of computer operations and comprising instructions executable by the processor and configured for receiving input data from one or more databases, identifying cognitive data attributes comprising one or more contextual, semantic, and temporal attributes from the received input data, adaptively simulate cognitive data absent in a spectrum of the received input data to provide a first data of the identified cognitive data attributes, identifying semantic divergence of the identified cognitive data attributes, providing a standardized data of the identified cognitive data attributes from the first data, grouping the standardized data based on time intervals, provide a high-dimensional cognitive data from the standardized data, wherein the high-dimension cognitive data comprises information of the transition of the cognitive data attributes at various time intervals, compressing the high-dimensional cognitive data, determining decision making rules, by the cognitive transformer engine, wherein the decision making rules are determined dynamically based on the high-dimensional cognitive data and comprises at least one of clustering, left/right (L-system) decision making rule, and composite rules, analyzing the compressed high-dimensional cognitive data to derive insights of interconnected data paths to desired outcomes based on the decision making rules and providing recommendations based on an outcome of the analysis to a user.

This summary is provided to introduce a selection of concepts in a simple manner that is further described in the detailed description of the disclosure. This summary is not intended to identify key or essential inventive concepts of the subject matter nor is it intended for determining the scope of the disclosure.

To further clarify advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1A is an illustration of a scaling adaptive data system (ADS) architecture, in accordance with an embodiment of the present disclosure;

FIG. 1B illustrates an adaptive data system (ADS) 100 for cognitive data processing, in accordance with an embodiment of the present disclosure;

FIG. 2 illustrates a method for cognitive data processing, in accordance with an embodiment of the present disclosure; and

FIG. 3 illustrates the dynamic cognitive transformer engine, in accordance with an embodiment of the present disclosure.

Further, persons skilled in the art to which this disclosure belongs will appreciate that elements in the figures are illustrated for simplicity and may not have been necessarily drawn to scale. Furthermore, in terms of the construction, the ADS and one or more components of it may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

In the present disclosure, relational terms such as first and second, and the like, may be used to distinguish one entity from the other, without necessarily implying any actual relationship or order between such entities.

The terms “comprise”, “comprising”, or any other variations thereof, are intended to cover a non-exclusive inclusion, such that a process or method that comprises a list of steps does not include only those steps but may include other steps not expressly listed or inherent to such a process or a method. Similarly, one or more elements or structures or components preceded by “comprises . . . a” does not, without more constraints, preclude the existence of other elements, other structures, other components, additional devices, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The components, methods, and examples provided herein are illustrative only and not intended to be limiting.

Embodiments of the present disclosure relate to adaptive data system (ADS) with low frequency processing of cognitive data.

### Cognitive Data

Cognitive data ( [symbol] ₐ) represents information enriched with contextual, semantic, and temporal attributes for human-like reasoning. One example of processing cognitive data is in healthcare applications. In healthcare applications cognitive data processing can significantly enhance patient care wherein vast amounts of data, including electronic health records (EHRs), medical imaging, lab results, and clinical notes, is processed to assist doctors in diagnosis and treatment planning. In one embodiment, the patient data having cognitive data ( [symbol] ₐ) is represented as follows:

$${a}_{} = \{ ( {x}_{i} , {ψ}_{i} , {τ}_{i} , {Ω}_{i} ) \vert {x}_{i} ∈ {ℝ}^{d} , \}$$

Wherein,

Feature Vector (x_i) represents patient attributes such as age, symptoms, blood pressure, and lab results.

Semantic Context (psi_i or ψᵢ) represents domain-specific ontology, for example, “Cardiology Ontology” or “Oncology Ontology”.

Temporal Signature (tau_i or τᵢ) represents timestamps for when data was collected or updated.

Observed Intent (mathcal{O} _i or Ωᵢ) represents labels indicating potential health risks or conditions, such as “Risk of heart disease” or “Diabetes management”.

In one example, the cognitive data received from a patient's record might include:

x_i = [72,years, 140/90,BP, 98° F] (age, blood pressure, temperature).
psi_i = “Hypertension Risk Ontology”.
tau_i= “2025-04-04T10:30:00Z” (timestamp).
mathcal{O}_i = “Potential cardiac event risk” $ (observed intent).

### Cognitive AI Models

Cognitive AI models, also known as cognitive computing, refer to a type of artificial intelligence system that aims to mimic human thought processes and cognitive abilities to solve complex problems. Unlike traditional AI models, which primarily rely on predefined rules and statistical analysis, cognitive AI models have the ability to learn from data, reason, and make decisions in a manner that resembles human cognition.

### Cognitive Data Processing

ADS introduces a paradigm shift in data processing by mimicking human thought processes and cognitive abilities. Unlike traditional approaches that rely on predefined rules and statistical analysis, ADS analyzes data in a holistic and context-aware manner.

### Low-Frequency Processing Using Cognitive Data

The concept of low-frequency processing is inspired by the efficiency of the human brain. Unlike traditional data processing systems that operate at high frequencies, ADS processes information at lower frequencies, mimicking the cognitive processes of the human brain. In the adaptive data system, the cognitive data is arranged like a maze. There are relationships between data paths and the cognitive data transformation allows data to be viewed from more than two dimensions. Cognitive data provides insight into the interconnect paths to desired outcomes utilizing simple left/right (L-system) decisions.

In the ADS, the cognitive data is processed by applying decision making rules to derive insights of interconnected data paths to desired outcomes. The decision making rules can be dynamic and based on clustering, left/right (L-system) decision making rule, and composite rules. It is to be noted that the dynamic determining of the decision making rules enable low-frequency, low-compute processing of the high-dimensional cognitive data. Hence, the ADS is referred to as low frequency, low compute system for processing cognitive data.

This cognitive approach enables ADS to analyze data in a more holistic and context-aware manner, capturing subtle nuances and patterns that may be overlooked by traditional systems. The key advantage of low-frequency processing is its ability to adapt to the dynamic nature of data and respond to changing environmental conditions. By operating at lower frequencies, ADS can identify trends, anomalies, and emerging patterns in real-time, enabling organizations to make faster, more informed decisions.

### Adaptive Symbolic Encoding

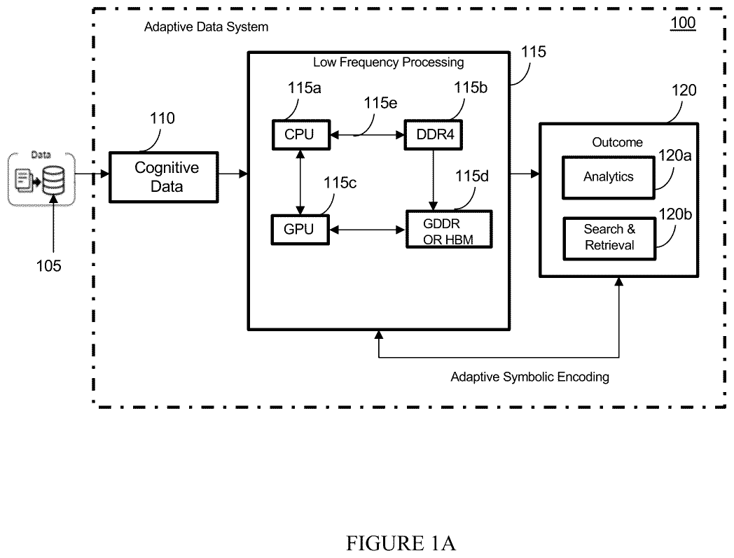

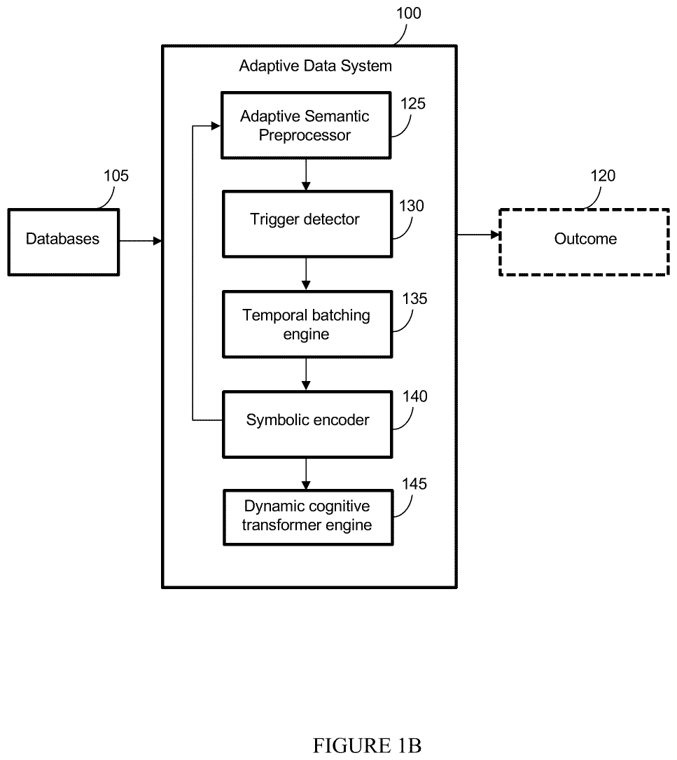

In addition to low-frequency processing, ADS employs adaptive symbolic encoding to dynamically adjust representations based on the characteristics of the data as illustrated in FIG. 1A. The ADS 100 iteratively refines its symbolic language to optimize it for specific data patterns, ensuring optimal performance and adaptability across diverse datasets and domains.

The adaptive nature of symbolic encoding allows ADS 100 to evolve and learn from new data inputs, continuously improving its ability to interpret and analyze complex data. This adaptability is crucial in dynamic environments where data patterns may change rapidly, ensuring that ADS 100 remains effective and relevant over time.

In adaptive data systems, data is transformed to cognitive data which is low frequency processing using adaptive symbolic encoding.

### Synergy of Components

FIG. 1A illustrates the various components in the ADS 100 architecture. Data received from a plurality of databases 105 is processed to generate cognitive data 110. Further, low frequency processing 115 is performed on the cognitive data 110. The low frequency processing 115 is performed using system components such as central processing unit (CPU) or processor 115a, a double data rate (DDR4) memory 115b, graphics double data rate (GDDR) or high bandwidth memory (HBM) 115d, and graphical processing unit (GPU) or processor 115c. The outcome 120 of the low frequency processing 115 includes but is not limited to analytics 120a and search and retrieval 120b of data.

The synergy between low-frequency processing and adaptive symbolic encoding forms the backbone of ADS's 100 architecture, enabling it to achieve unparalleled performance and efficiency. By combining these two key components, ADS 100 can oversee a wide range of data processing tasks with ease, from real-time analytics to predictive modeling and beyond.

The adaptive nature of ADS's 100 architecture ensures that it can adapt to the evolving needs of organizations, providing a flexible and scalable solution that can grow and evolve alongside their data requirements. This adaptability is crucial in today's fast-paced business environment, where organizations need agile, responsive solutions to stay ahead of the competition.

### Equilibrium Optimization

In the real-world scenario the data, infrastructure and outcomes are scaled with different factors and dynamics. The cognitive data standardization plays a key role in shaping complex systems as we move forward with machine learning, artificial intelligence, and analytics. The current eco-system is growing with this dynamics without any foundational standardization such as data standardization. Cognitive data standardization can be a way forward to keep these eco-systems at equilibrium.

The ADS 100 architecture is designed to treat data, infrastructure, and expected outcomes as a single entity living in equilibrium within the ecosystem. By leveraging cognitive data processing capabilities, ADS 100 acts as an agent to maintain this equilibrium optimally, ensuring that the system remains aligned with expected outcomes despite scaling factors and dynamics in the real world. The equilibrium optimization is crucial for shaping complex systems as we continue to advance in machine learning, artificial intelligence, and analytics. Cognitive data standardization plays a key role in maintaining this equilibrium, providing a foundational framework for harmonizing diverse data sources and ensuring coherence within the ecosystem.

Key features to maintain equilibrium include:

Adaptive Infrastructure Scaling: The ADS 100 dynamically adjusts infrastructure resources such as CPU, GPU, memory, storage, and network capacity to meet evolving data processing requirements, ensuring optimal performance and efficiency.

Continuous Learning and Adaptation: The ADS 100 continuously learns from new data inputs and adapts its processing algorithms and strategies to optimize performance and adaptability over time.

Real-Time Monitoring and Optimization: The ADS 100 incorporates real-time monitoring and optimization mechanisms to detect anomalies, identify optimization opportunities, and ensure that the system remains aligned with expected outcomes.

By embracing these principles of equilibrium optimization, the ADS 100 empowers organizations to navigate the complexities of modern data environments with agility, efficiency, and intelligence.

FIG. 1B illustrates the adaptive data system (ADS) 100 for cognitive data processing, in accordance with an embodiment of the present disclosure. The ADS 100 includes an adaptive semantic preprocessor 125. The adaptive semantic preprocessor 125 is configured to receive input data from one or more databases 105. The adaptive semantic preprocessor 125 identifies cognitive data attributes comprising one or more contextual, semantic, and temporal attributes from the received input data. Unlike traditional artificial intelligence (AI) models which uses correlation to find the similarity between the data, the adaptive semantic preprocessor 125 uses convolution to find the influence of data or data attributes. By using correlation, the ADS 100 can build small models instead of large models that are typically built in traditional AI models.

In the spectrum of data received, at times, some of the cognitive data 110 is missed or are absent. The adaptive semantic preprocessor 125 adaptively simulates the cognitive data absent in the spectrum of the received input data. The complete spectrum of data, also referred to as the first data of the identified cognitive data attributes, is then given for further processing. Further, the adaptive semantic preprocessor 125 is configured to monitor the received input data for variation in the identified cognitive data attributes and update the first data, making the semantic preprocessor 125 adaptive to the changes in data.

The ADS 100 includes a trigger detector 130. The trigger detector 130 is configured to identify semantic divergence of the identified cognitive data attributes. The Semantic divergence refers to the difference in meaning between words, phrases, or sentences across different languages, or even within the same language over time. In the case of health care application, the ADS 100 continuously monitors incoming patient data for significant changes in semantic context. This is achieved by computing the Kullback-Leibler divergence (KL) divergence between the current and previous semantic states. The KL divergence is a non-symmetric metric that measures the relative entropy or difference in information represented by two distributions. It is the measure of the distance between two data distributions showing how different the two distributions are from each other. If a patient's symptoms change drastically (e.g., sudden chest pain), the trigger detector 130 triggers low-frequency processing.

The semantic divergence can be calculated as follows:

$$Trigger = \{ \begin{matrix}1 & if K L ( {ψ}_{t} \text{\vert \vert} {ψ}_{t - 1} ) > ϵ \\ 0 & otherwise\end{matrix}$$

Where, for example, Divergence threshold ε=0.25.

The trigger detector 130 provides a standardized data of the identified cognitive data attributes from the first data. The trigger detector 130 is configured to identify variations in the identified cognitive data attributes and perform low frequency processing 115 of the standardized data to process the variations in the standardized data.

The ADS 100 includes a temporal batching engine 135 configured to group the standardized data based on time intervals. The temporal batching engine 135 provide a high-dimensional cognitive data from the standardized data. The high-dimension cognitive data includes information of the transition of the cognitive data attributes at various time intervals. The temporal batching engine 135 provides information of the transition of the cognitive data attributes at various time intervals as follows:

$${B}_{k} = {⋃}_{{τ}_{i} ∈ [ t - Δ t , t ]} {x}_{i} where Δ t ∝ \frac{1}{TriggerFrequency}$$

Unlike traditional AI models that uses data clustering, the temporal batching engine 135 enables grouping of data having dependent features as well as independent features. For example, patient data is grouped into batches based on time intervals. For instance, all test results within the last hour are grouped for analysis.

The temporal batching engine 135 is optional. In one embodiment, The ADS 100 does not group the standardized data based on time intervals, instead proceeds to compressing the standardized data using a symbolic encoder 140.

The ADS 100 includes the symbolic encoder 140 for compressing the high-dimensional cognitive data received from the temporal batching engine 135. The batched data is compressed into symbolic representations using Symbolic Aggregate Approximation (SAX).

$${S}_{k} = S A X ( {B}_{k} , w = 8 , α = 5 ) ( Symbolic Aggregate Approximation )$$

The symbolic encoder 140 uses sum and aggregation on the high-dimensional cognitive data symbolic encoding to achieve a pattern. In one embodiment, the symbolic encoder 140 uses Symbolic Aggregate Approximation (SAX) and Graph Attention Networks (GAT) for determining relationships between the identified cognitive data attributes. The symbolic encoder 140 compresses the high-dimensional cognitive data based on symbolic representation of the cognitive data attributes in the standardized data. Further, the symbolic encoder 140 provides reinforcement learning through symbolic feedback. The symbolic feedback is specific feedback provided to the adaptive semantic preprocessor 125. The adaptive semantic preprocessor 125 performs low frequency processing 115 of the first data of the identified cognitive data attributes to process the specific feedback.

In one embodiment, adaptive symbolic encoding in healthcare includes the following steps:

### Step 1: Feature Extraction

Patient features are processed using graph attention networks:

$${z}_{i} = {f}_{G A T} ( {x}_{i} , {G}_{ψ} )$$

This step extracts relevant features from the patient data, considering the semantic context.

### Step 2: Symbol Matching

Extracted features are matched to existing symbols in the dictionary:

$${s}_{i} = arg {min}_{{σ}_{j}} ( dist ( {z}_{i} , {σ}_{j} ) )$$

If a feature matches an existing symbol, it is encoded accordingly.

### Step 3: Dictionary Update

If no match exists (e.g., a rare symptom), a new symbol is added:

$${s}_{n e w} = {z}_{i} , \vert {\sum }_{t} \vert = \vert {\sum }_{t - 1} \vert + 1$$

This ensures the system adapts to new conditions or patterns as they emerge.

### Step 4: Feedback Learning

The dictionary adapts based on reinforcement learning:

$${L}_{feedback} = {‖ {s}_{predicted} - {s}_{actual} ‖}^{2}$$

This feedback loop ensures continuous improvement in the accuracy of the ADS 100.

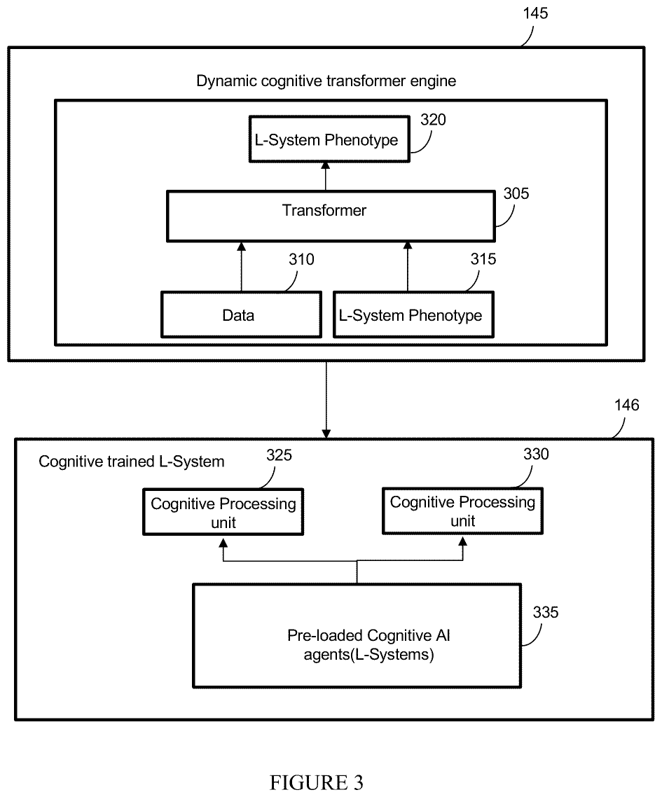

The ADS 100 includes a dynamic cognitive transformer engine 145. The dynamic cognitive transformer engine 145 is configured to determine decision making rules. The decision making rules are determined dynamically based on the high-dimensional cognitive data and comprises at least one of clustering, left/right (L-system) decision making rule, and composite rules. The dynamic cognitive transformer engine 145 analyzes the compressed high-dimensional cognitive data to derive insights of interconnected data paths to desired outcomes based on the decision making rules. Further, the dynamic cognitive transformer engine 145 provides recommendations based on an outcome of the analysis to a user. It is to be noted that the dynamic determining of the decision making rules enable low-frequency, low-compute processing of the high-dimensional cognitive data. The dynamic cognitive transformer engine 145 adapts to change in the first data of the identified cognitive data attributes. FIG. 3 illustrates the dynamic cognitive transformer engine 145, in accordance with an embodiment of the present disclosure.

Referring to FIG. 3, the dynamic cognitive transformer engine 145, includes a transformer 305. The transformer transforms any new data 310 by applying the decision-making rules, using the L-system phenotype 315 and generates the optimal L-system phenotype 320. Further, the dynamic cognitive transformer engine 145 includes pre-loaded cognitive AI agents 335 which are already trained with a specific decision making rules. These pre-loaded cognitive AI agents 335 are processed using one or more cognitive processing units (325, 330). FIG. 3 illustrates the cognitive trained L-system 146. The cognitive trained L-system 146, includes the optimal L-system phenotype 320 for various use cases of data pre-loaded cognitive AI agents 335 which are already trained with specific decision making rules. These pre-loaded cognitive AI agents 335 are processed using one or more cognitive processing units (325, 330) which are the low frequency processing units built to run L-Systems.

In one embodiment, the adaptive data system 100 for cognitive data processing includes a processor 115a. The ADS 100 includes a data bus 115e coupled to the processor 115a. Further, ADS 100 includes a non-transitory, computer-readable storage medium embodying computer program code, the non-transitory, computer-readable storage medium being coupled to the data bus 115e, the computer program code interacting with a plurality of computer operations and comprising instructions executable by the processor 115a and configured for receiving input data from one or more databases 105. The processor 115a identifies cognitive data attributes comprising one or more contextual, semantic, and temporal attributes from the received input data and adaptively simulating cognitive data absent in a spectrum of the received input data to provide a first data of the identified cognitive data attributes. Further, the processor 115a identifies semantic divergence of the identified cognitive data attributes and provides a standardized data of the identified cognitive data attributes from the first data. Further, the processor 115a groups the standardized data based on time intervals and provides a high-dimensional cognitive data from the standardized data. The high-dimension cognitive data comprises information of the transition of the cognitive data attributes at various time intervals. The processor 115a compresses the high-dimensional cognitive data and analyzes the compressed high-dimensional cognitive data. The analyzing includes applying left/right (L-system) decision making rules on the high-dimensional cognitive data to derive insights of interconnected data paths to desired outcomes and providing recommendations based on an outcome of the analysis to a user. The applying the left/right (L-system) decision making rules enable low-frequency, low-compute processing of the high-dimensional cognitive data.

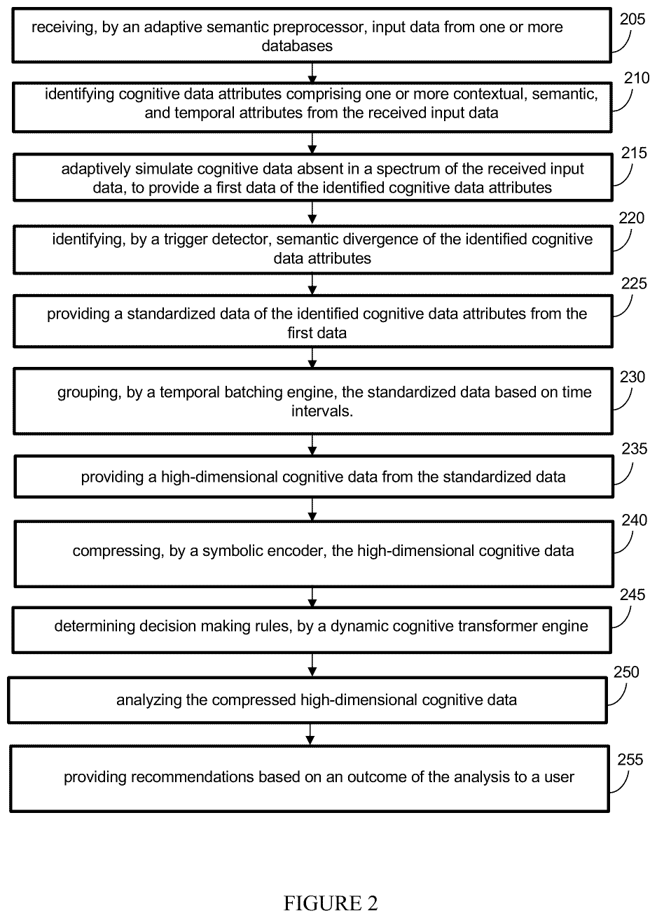

FIG. 2 illustrates a method for cognitive data processing, in accordance with an embodiment of the present disclosure.

At step 205, the method includes receiving, by the adaptive semantic preprocessor 125, input data from one or more databases.

At step 210, the method includes identifying, by the adaptive semantic preprocessor 125, cognitive data attributes comprising one or more contextual, semantic, and temporal attributes from the received input data.

At step 215, the method includes adaptively simulating cognitive data absent in a spectrum of the received input data, by the adaptive semantic preprocessor 125, to provide a first data of the identified cognitive data attributes. The method includes monitoring, by the adaptive semantic preprocessor, the received input data for variation in the identified cognitive data attributes and updating the first data.

At step 220, the method includes identifying, by the trigger detector 130, semantic divergence of the identified cognitive data attributes.

At step 225, the method includes providing a standardized data of the identified cognitive data attributes from the first data. The method includes identifying, by the trigger detector 130, variations in the identified cognitive data attributes and performing low frequency processing of the standardized data to process the variations in the standardized data.

At step 230, the method includes grouping, by the temporal batching engine 135, the standardized data based on time intervals.

At step 235, the method includes providing a high-dimensional cognitive data from the standardized data, wherein the high-dimension cognitive data comprises information of the transition of the cognitive data attributes at various time intervals.

At step 240, the method includes compressing, by the symbolic encoder 140, the high-dimensional cognitive data. Compressing the high-dimensional cognitive data is based on symbolic representation of the cognitive data attributes in the standardized data. The method includes providing reinforcement learning through symbolic feedback. The symbolic feedback is specific feedback provided to the adaptive semantic preprocessor. Further, the method includes performing, by the adaptive semantic preprocessor, low frequency processing of the first data of the identified cognitive data attributes to process the specific feedback.

At step 245, the method includes determining decision making rules, by the dynamic cognitive transformer engine 145. The decision making rules are determined dynamically based on the high-dimensional cognitive data and comprises at least one of clustering, left/right (L-system) decision making rule, and composite rules. The method includes transforming any new data by applying the decision-making rules, using the L-system phenotype, and generating the optimal L-system phenotype. If the data is not new and is from an existing use case or application, then the method includes applying the pre-loaded cognitive AI agents that are already trained with specific decision making rules for the specific use case.

At step 250, the method includes analyzing, by the dynamic cognitive transformer engine 145, the compressed high-dimensional cognitive data to derive insights of interconnected data paths to desired outcomes based on the decision making rules.

At step 255, the method includes providing recommendations based on an outcome of the analysis to a user.

The ADS 100 finds application in many domains. The advantage of ADS 100 in healthcare application includes the following:

Enhanced Diagnostics: The system analyzes patterns in patient data to identify anomalies and recommend treatments. For example, detecting early signs of heart disease from EHRs and lab results and recommending personalized medication based on patient history.

Efficiency: By batching data and using symbolic encoding, the system reduces computational overhead by avoiding continuous processing.

Adaptability: The system evolves as new medical conditions or treatments emerge, ensuring relevance over time.

Personalized Care: Adaptive symbolic encoding tailor recommendations to individual patients by dynamically updating its symbol dictionary.

Applications beyond healthcare include Finance: Fraud detection by analyzing transaction patterns and flagging anomalies, Retail: Personalized shopping experiences through adaptive customer profiling, Education: Dynamic learning pathways tailored to student progress, Industrial Monitoring: Predictive maintenance based on sensor data trends. The ADS 100 demonstrates versatility across industries by leveraging cognitive computing principles for dynamic and efficient decision-making tailored to specific applications.

While specific language has been used to describe the disclosure, any limitations arising on account of the same are not intended. As would be apparent to a person skilled in the art, various working modifications may be made to the method to implement the inventive concept as taught herein.

The figures and the description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible.

What is claimed is:

1. An adaptive data system for cognitive data processing, the adaptive data system comprising:
an adaptive semantic preprocessor configured to:
receive input data from one or more databases;
identify cognitive data attributes comprising one or more contextual, semantic, and temporal attributes from the received input data; and
adaptively simulate cognitive data absent in a spectrum of the received input data to provide a first data of the identified cognitive data attributes;
a trigger detector configured to:
identify semantic divergence of the identified cognitive data attributes; and
provide a standardized data of the identified cognitive data attributes from the first data;
a temporal batching engine configured to:
group the standardized data based on time intervals; and
provide a high-dimensional cognitive data from the standardized data, wherein the high-dimension cognitive data comprises information of the transition of the cognitive data attributes at various time intervals;
a symbolic encoder for compressing the high-dimensional cognitive data; and
a dynamic cognitive transformer engine configured to:
determine decision making rules, wherein the decision making rules are determined dynamically based on the high-dimensional cognitive data and comprises at least one of clustering, left/right (L-system) decision making rule, and composite rules;
analyzing the compressed high-dimensional cognitive data to derive insights of interconnected data paths to desired outcomes based on the decision making rules; and
provide recommendations based on an outcome of the analysis to a user.

2. The method as claimed in claim 12, wherein the dynamic determining of the decision making rules enable low-frequency, low-compute processing of the high-dimensional cognitive data.

3. The adaptive data system as claimed in claim 1, wherein the adaptive semantic preprocessor is configured to:
monitor the received input data for variation in the identified cognitive data attributes; and
update the first data.

4. The adaptive data system as claimed in claim 1, wherein the trigger detector is configured to:
identify variations in the identified cognitive data attributes; and
perform low frequency processing of the standardized data to process the variations in the standardized data.

5. The adaptive data system as claimed in claim 1, wherein the symbolic encoder uses Symbolic Aggregate Approximation (SAX) and Graph Attention Networks (GAT) for determining relationships between the identified cognitive data attributes.

6. The adaptive data system as claimed in claim 1, wherein the symbolic encoder compresses the high-dimensional cognitive data based on symbolic representation of the cognitive data attributes in the standardized data.

7. The adaptive data system as claimed in claim 1, wherein the symbolic encoder provides reinforcement learning through symbolic feedback.

8. The adaptive data system as claimed in claim 7, wherein the symbolic feedback is specific feedback provided to the adaptive semantic preprocessor.

9. The adaptive data system as claimed in claim 8, wherein the adaptive semantic preprocessor performs low frequency processing of the first data of the identified cognitive data attributes to process the specific feedback.

10. The adaptive data system as claimed in claim 1, wherein the dynamic cognitive transformer engine adapts to change in the first data of the identified cognitive data attributes.

11. A method for cognitive data processing, the method comprising:
receiving, by an adaptive semantic preprocessor, input data from one or more databases;
identifying, by the adaptive semantic preprocessor, cognitive data attributes comprising one or more contextual, semantic, and temporal attributes from the received input data;
adaptively simulating cognitive data absent in a spectrum of the received input data, by the adaptive semantic preprocessor, to provide a first data of the identified cognitive data attributes;
identifying, by a trigger detector, semantic divergence of the identified cognitive data attributes;
providing a standardized data of the identified cognitive data attributes from the first data;
grouping, by a temporal batching engine, the standardized data based on time intervals;
providing a high-dimensional cognitive data from the standardized data, wherein the high-dimension cognitive data comprises information of the transition of the cognitive data attributes at various time intervals;
compressing, by a symbolic encoder, the high-dimensional cognitive data;
determining decision making rules, by the cognitive transformer engine, wherein the decision making rules are determined dynamically based on the high-dimensional cognitive data and comprises at least one of clustering, left/right (L-system) decision making rule, and composite rules;
analyzing the compressed high-dimensional cognitive data to derive insights of interconnected data paths to desired outcomes based on the decision making rules; and
providing recommendations based on an outcome of the analysis to a user.

12. The method as claimed in claim 12, wherein the dynamic determining of the decision making rules enable low-frequency, low-compute processing of the high-dimensional cognitive data.

13. The method as claimed in claim 12, comprising:
monitoring, by the adaptive semantic preprocessor, the received input data for variation in the identified cognitive data attributes; and
updating the first data.

14. The method as claimed in claim 11, comprising:
identifying, by the trigger detector, variations in the identified cognitive data attributes; and
performing low frequency processing of the standardized data to process the variations in the standardized data.

15. The method as claimed in claim 11, wherein compressing the high-dimensional cognitive data is based on symbolic representation of the cognitive data attributes in the standardized data.

16. The method as claimed in claim 11, comprising providing reinforcement learning through symbolic feedback.

17. The method as claimed in claim 16, wherein the symbolic feedback is specific feedback provided to the adaptive semantic preprocessor.

18. The method as claimed in claim 17, comprising performing, by the adaptive semantic preprocessor, low frequency processing of the first data of the identified cognitive data attributes to process the specific feedback.

19. An adaptive data system for cognitive data processing, the adaptive data system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving input data from one or more databases;
identifying cognitive data attributes comprising one or more contextual, semantic, and temporal attributes from the received input data;
adaptively simulating cognitive data absent in a spectrum of the received input data to provide a first data of the identified cognitive data attributes;
identifying semantic divergence of the identified cognitive data attributes;
providing a standardized data of the identified cognitive data attributes from the first data;
grouping the standardized data based on time intervals;
providing a high-dimensional cognitive data from the standardized data, wherein the high-dimension cognitive data comprises information of the transition of the cognitive data attributes at various time intervals;
compressing the high-dimensional cognitive data;
determining decision making rules, by the cognitive transformer engine, wherein the decision making rules are determined dynamically based on the high-dimensional cognitive data and comprises at least one of clustering, left/right (L-system) decision making rule, and composite rules;
analyzing the compressed high-dimensional cognitive data to derive insights of interconnected data paths to desired outcomes based on the decision making rules; and
providing recommendations based on an outcome of the analysis to a user.

20. The adaptive data system for cognitive data processing as claimed in claim 19, wherein the dynamic determining of the decision making rules enable low-frequency, low-compute processing of the high-dimensional cognitive data.
